(19) United States
(12) Patent Application Publication
(10) Pub. No.: US 2015/0052156 A1
(43) Pub. Date: Feb. 19, 2015

(54) RANKING ORGANIZATIONS ACADEMICALLY & RATIONALLY (ROAR)

(71) Applicants: Ge Wang, Latham, NY (US); Jiansheng Yang, Beijing (CN)

(72) Inventors: Ge Wang, Latham, NY (US); Jiansheng Yang, Beijing (CN)

(21) Appl. No.: 14/459,899

(22) Filed: Aug. 14, 2014

Related U.S. Application Data
(60) Provisional application No. 61/866,097, filed on Aug. 15, 2013.

(51) Int. Cl. G06F 17/30

(52) U.S. Cl. CPC G06F 17/30386; G06F 17/30861
USPC 707/751

(57) ABSTRACT

A computer-implemented process that utilizes digital and/or other resources to objectively rank a subject based on publications having a plurality of authors. The system assigns individualized credit to each subject axiomatically. The system finds self-citations pertaining to each subject and removes such self-citations. The system then ranks the subject objectively, typically through automatic data mining.

### RELATED APPLICATIONS

This application claims priority to and the benefit of the filing date of U.S. provisional application Ser. No. 61/866,097 filed Aug. 15, 2013 and incorporated herein for all purposes.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

Improving an academic organization's standing in publications such as the US News & World Report (USNWR) is a priority of many university administrators and faculty members. Other ranking systems and reports are also of reference value; for example, the Academic Ranking of World Universities (ARWU). No matter what the ranking system is used, the ranking assigned has widespread impact including financial and social implications. For example, it is widely used by potential students to select universities.

The current ranking methods are commonly based on survey, analysis and synthesis. Thus, subjective opinions play a role in the rankings. For example, the subjective selection of the various weighting criteria used leads to different ranking lists. This subjective aspect can result in producing preferred outcomes, which can be influenced by efforts to induce favorable scoring. This inconsistency and confusion in practice could compromise the credibility and impact of the current academic ranking results.

The need for an objective ranking system is highlighted by the fact that in the field of computer science, the number of annual publications (including journal and conference papers) has increased from 10,000 forty years ago to over 200,000 recently. The average number of coauthors has been increased from 1.25 to 3.12 over the past 50 years. Some papers may even have more than 100 co-authors. Also, it is known that authors tend to cite their own work more often. Thus, for an unbiased academic assessment or ranking, the assignment of credits to co-authors and self-citations should be addressed.

In an effort to create an unbiased assessment, in 2005, the h-index was developed as a bibliometric indicator, and various other bibliometric indicators have since been developed. Yet, most of these indicators do not differentiate coauthors' relative contributions. There are two popular approaches for crediting coauthors. The first one lets each co-author receive the full credit. The second one gives every coauthor an equal credit. These measures are evidently too rough, since co-authors' contributions to a paper can be rather uneven.

To address this, the harmonic allocation method was designed. In this scheme, the weight of the k-th co-author is subjectively set to

$$\frac{1}{k} / {\sum }_{i = 1}^{n} \frac{1}{i} ,$$

where n is the number of co-authors. An alternative credit sharing method was also proposed based on heuristics. Nevertheless, the hbar-index does not extract coauthors' credit shares on any specific paper. There is no rationale behind the proportionality that the k-th author contributes 1/k as much as the first author's contribution. Realistically, there are many possible ratios between the k-th and the first authors' credits, which may be equal or may be rather small such as in the cases of data sharing or technical assistance. Despite its superiority to the fractional method, the harmonic method has not been practically used, because of its subjective nature. On the other hand, the axiomatic credit-sharing scheme, the a-index, has also been developed to assign credit using an axiomatically derived system.

Since 1983, the US News & World Report (USNWR) has published an annual listing of American Best Colleges. Inspired by USNWR, other ranking results emerged using different methods. There are now more than 50 different systems for ranking institutions. Most of these rankings use the weighted-sum mechanism. They rely on some relevant (correlated, to different degrees) indicators, and use the sum of weighted scores to determine the rank of an institution.

The Academic Ranking of World Universities (ARWU) is another example of a ranking system that uses data available since 2003. In the field of computer science, the ARWUL ranking relies on the five bibliometric indicators (http://www.shanghairanking.com/ARWU-SUBJECT-Methodology-2011.html): (1) Alumni (10%), as quantified by the number of alumni winning Turning Awardees since 1961; (2) Award (15%), the number of faculty winning Turning Awardees since 1961: (3) HiCi (25%), the number of highly cited papers; (4) PUP (25%), the number of papers indexed in the Science Citation Index (SCI); and (5) TOP (25%), the percentage of papers published in the top 20% journals in the field. In each category, the university with the maximum score receives 100 points, and the other universities are measured in terms of percentages relative to the maximum score. The total credit for a university is a weighted sum of the five measures.

In addition to the above indicators, there are other variants and features. Yet, it is highly non-trivial how to select from indicators and how to weight them. For example, academic productivity and research funding have been hot topics in biomedical research. While publications and their citations are popular indicators of academic productivity, there has been no rigorous way to quantify co-authors' relative contributions. This has seriously compromised quantitative studies on the relationship between academic productivity and research funding. As found in one recent study (D. K. Ginther et al.: “Race, ethnicity, and NIH research awards,” Science, 19 Aug. 2011, p. 1015) (Ginther, Schaffer et al. 2011), the probability of receiving a U.S. National Institutes of Health (NIH) R01 award was allegedly related to the applicant's race/ethnicity. The paper finds that black/African-American applicants were 10% less likely than white peers to receive an award after control for background and qualification, and suggested “leverage points for policy intervention” (Ginther, Schaffer et al. 2011). These findings have generated a widespread debate regarding the unfairness of the NIH grant review process and its correction. The moral imperative is clear that any racial bias is not to be tolerated, particularly in the NIH funding process. However, the question of whether such a racial bias truly exists requires rigorous and systematic evaluation.

### BRIEF SUMMARY OF THE INVENTION

In one embodiment, the present invention provides a ranking methodology that utilizes comprehensive web resources or other digital data, credits team members/co-authors axiomatically, and quantifies academic outputs objectively and rationally. In another embodiment, the present invention takes advantage of the rapid development of web science and technology, by providing a ranking system that uses web-based data-mining techniques of digital content to create ranking results as applied to a subject. The subject may be authors, co-authors, departments, colleges, contributors, universities, companies or any other entity that may be ranked using the published works associated with the entity.

The rankings resulting from the invention may then be used in grant selection, grant management, to monitor efficiency, determine potential bias (white versus black, male versus female, junior versus senior, etc.) and in other applications in which an objective analysis of performance or some other metric is desired.

In yet another embodiment, the present invention provides a method that refines the number of citations using the a-index and excludes self-citations proportionally. After a co-author or academic unit, which may be composed of one or more authors, of a paper receives an appropriate credit according to the a-index, he or she will obtain his or her own share of the total number of citations to that paper. Citations will be excluded from one's share of a paper to his/her share of another paper. The present invention then provides an ah-index such that a co-author has an ah-index value x if he or she has at most x papers to which his or her pure share of the total number of citations is at least x. By using these refinements, as will be discussed in more detail below, vast amounts of web-based metadata, and the vast amounts of research output can be quantified as a foundation for fair and open ranking.

### BRIEF DESCRIPTION OF THE SEVERAL VIEWS OF THE DRAWINGS

FIG. 1 provides a pseudo code for computing a co-author's credit in a paper.

FIG. 2 is a flow chart for the axiomatic exclusion of self-citation.

FIG. 3 provides pseudo code for computing an institutional credit from all the involved papers.

### DETAILED DESCRIPTION OF THE INVENTION

This description is not to be taken in a limiting sense, but is made merely for the purpose of illustrating the general principles of the invention. The scope of the invention is defined by the appended claims.

Scientific publication is a main outcome of research and development. The number of citations is a well-accepted key observable on the impact of a paper. Accordingly, publications and citations have been widely used in ranking systems. Yet, scientific credit has not been individually assigned and comprehensively analyzed in the context of academic ranking. In one embodiment, the present invention calculates an individual co-author's or academic unit's credit in a specific paper using an axiomatic approach.

The axiomatic system consists of the three axioms: (1) Ranking Preference: a better ranked co-author has a higher credit; (2) Credit Normalization: the sum of individual credits equals 1; and (3) Maximum Entropy: co-authors' credit shares are uniformly distributed in the space defined by Axioms 1 and 2.

In other embodiments, if the co-authors did not make an equal contribution, then the k-th co-author of a paper by n co-authors has a credit share

$$\frac{1}{n} {\sum }_{j = k}^{n} \frac{1}{j} .$$

If the last author is the corresponding author, he or she can be considered as important as the first author. If there are no other two co-authors who have the same amount of credit, then the first or last authors credit's is

$$\frac{1}{n - 1} {\sum }_{j = 1}^{n - 1} \frac{1}{j + 1} ,$$

and the k-th co-author's credit is

$$\frac{1}{n - 1} {\sum }_{j = k}^{n - 1} \frac{1}{j + 1} ,$$

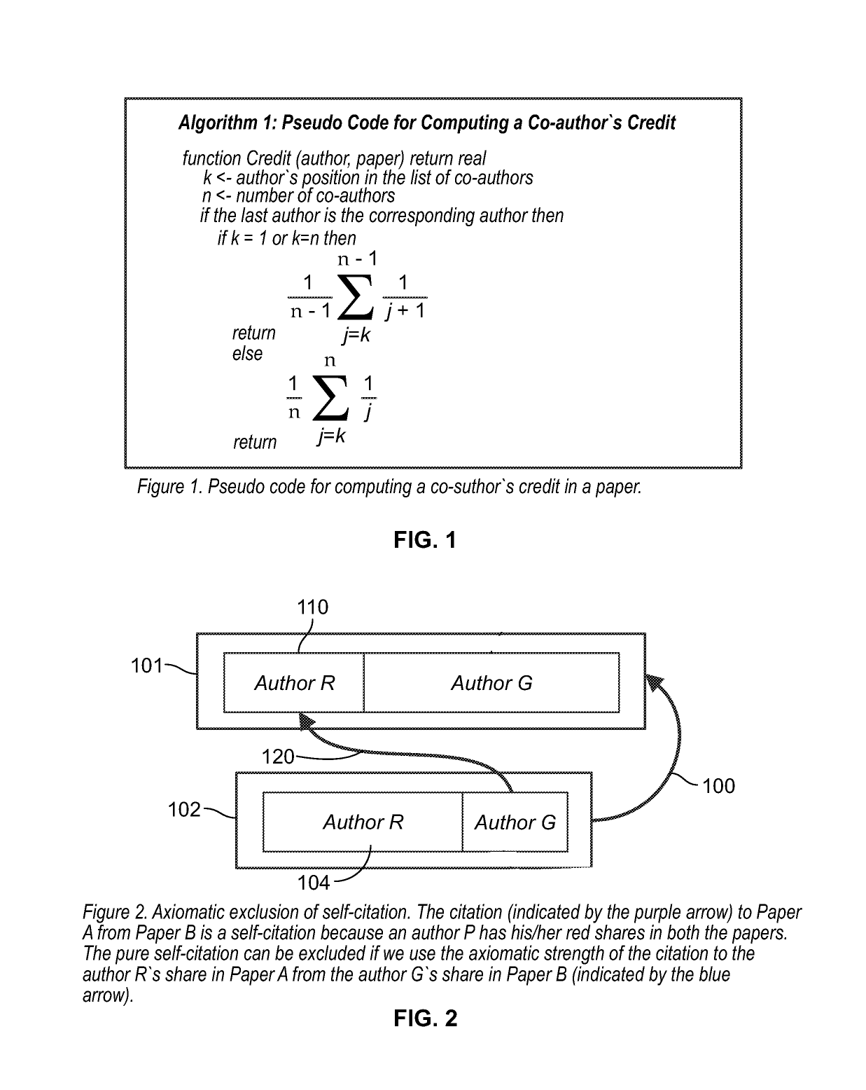

k≠1 and k≠n. FIG. 1 provides a pseudo code for computing a co-author's credit as set forth above.

Aided by the a-index described above, in another embodiment of the invention, the number of citations to a paper can be proportionally assigned to each co-author. A co-author with an a-index value c for a paper being cited M times gains c*M citations to that paper, which is referred to as the ac-index. In yet another even more preferred embodiment of the invention, that enhances the objectivity of the ranking, self-citations may be removed from the citations to a paper.

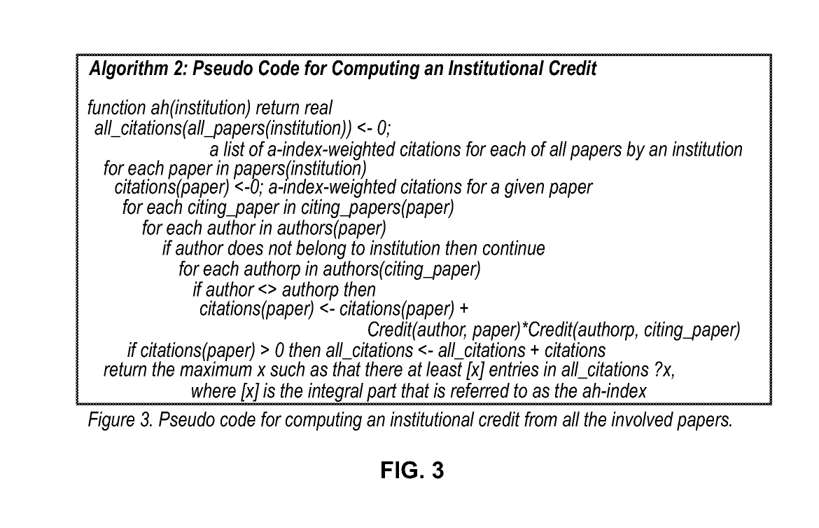

When a researcher publishes a paper, his or her institution gets a credit. The credit for an institution can be measured as the sum of the credits earned by those co-authors who are with the institution. Aided by the a-index, self-citations specific to individual co-authors and their related contributions are excluded. As shown in FIG. 2, citation 100 to publication 101 from publication 102 is a self-citation because an author R has his/her shares 104 and 110 in both the publications. The pure self-citation can be excluded by using the axiomatic strength of the citation of author R's share in publication 101 from author G's share in publication 102 as indicated by 120. An institutionally-oriented ah-index using the algorithm in FIG. 3 may be obtained by computing an institutional credit from all the involved papers.

In one application, an embodiment of the present invention uses a computer system and implemented method to perform data mining. For example, the invention may take advantage of the work of Microsoft Research, which performs basic and applied research in computer science and software engineering in more than 50 areas. It has expanded to eight locations worldwide with collaborative projects. Microsoft Academic Search (MAS) (http://academic.research.microsoft.com) is a free service of Microsoft Research to help study academic contents. This service not only indexes academic papers but also reveals relationships among subjects. Under this service, the number of publications is more than 40 million, and the number of authors more than 18.9 million. Thousands of new papers are integrated into the database regularly. In the domain of computer science, there are more than 6-million papers. About 40% of them are from journals. About 35% of them are from conference proceedings. The other papers do not have a clear association with either a journal or a conference.

The MAS search results are sorted, covering the entire spectrum of science, technology, medicine, social sciences, and humanities. The current partners are dozens of publishers and other content providers. The novel analytic features include the genealogy graph for advisor-advisee relationships based on the information mined from the web and user input, the paper citation graph showing the citation relationships among papers, the organization comparison in different domains, author/organization rank lists, the academic map presenting organizations geographically, the keyword detail with the Stemming Variations and Definition Context.

The software for processing data from MAS was mainly written in C/C++/C#/SQLASP.net on a dedicated system consisting of the following modules: Offline Data Processing, Metadata Extraction, Reference Building, Name Disambiguation, Online Index Building/Servicing, Data Presentation, and tools to support users' feedback and contribution.

In one application of the present invention, divisions, colleges, department or other subgroups may be ranked. In one implemented embodiment, American departments of computer science were ranked. One million papers from MAS were collected. In addition, metadata extraction, citation context extraction, reference matching within the I-million papers and citation analysis between the existing papers and newly added papers was performed by a computer system designed to implement the methods of the invention. This system and method is capable of handling up to 100-million documents using existing hardware and software. Information from MAS metadata, computed individual credits and excluded self-citations using the above-described algorithms may be used to perform the ranking. Additional information that may be extracted during data mining includes author specific information such as an email address and information from other electronic publications. Such information may be crosschecked with data mined from his/her academic homepage. Also, a user can make corrections or provide metadata using built-in tools.

An automatic module was also developed and used to analyze coauthors' names to eliminate any ambiguity in the cases of the same person with multiple email addresses, for different working organizations, by various name spellings, different individuals with the same name, and so on. When there was any error in the metadata, the whole entry was removed; for example, if the extraction of some or all author information was not successfully, the publication would be discarded.

In addition, a publication, such as a computer science paper, may receive a credit from a citing paper, which is not necessarily in the technical field. In the calculation, if one co-author provided his/her email in the paper, they may be treated as the corresponding author.

The present invention may be used to calculate the ranks of American departments of computer science by the ac- and ah-indices, the aj-index that is defined as the sum of the a-index weighted by the journal impact factor for each of all the papers associated with a department, and the aac-index defined as the averaged ac-index. Table 1 shows the relevant ranks by each of all these measures. The ac-index-based ranking reflects the overall impact in terms of “pure” citations from a department, and is emphasized in Table 1. The acc-index-based ranking is the normalization with respect to the number of coauthors associated with a department. The ah-index-based results represent a refinement to the h-index-based ranking. The aj-index is advantageous in terms of promptness and does not require citations.

TABLE 1
U.S. computer science departmental rankings.

| ac- | | ac- | aac- | ah- | aj-rank | # of | # of | ARWU² | USNWR³ |
|---|---|---|---|---|---|---|---|---|---|
| Rank | Institution | index | index | index | (2012)¹ | authors | papers | (2011) | (2010) |
| 1 | Massachusetts Institute | 274440.5 | 48.1 | 197 | 1 | 5711 | 43701 | 2 | 1 |
| | of Technology | | | | | | | | |
| 2 | Stanford University | 267123.6 | 50.7 | 205 | 2 | 5266 | 45798 | 1 | 1 |
| 3 | Carnegie Mellon | 234860.7 | 56.8 | 170 | 9 | 4137 | 42258 | 6 | 1 |
| | University | | | | | | | | |
| 4 | University of California | 234236.7 | 53.3 | 194 | 3 | 4397 | 39679 | 3 | 1 |
| | Berkeley | | | | | | | | |
| 5 | University of Illinois | 130772.0 | 34.7 | 129 | 4 | 3765 | 33008 | 11 | 5 |
| | Urbana Champaign | | | | | | | | |
| 6 | Georgia Institute of | 102320.4 | 27.5 | 112 | 11 | 3719 | 30509 | 19 | 10 |
| | Technology | | | | | | | | |
| 7 | University of Maryland | 90477.97 | 33.0 | 117 | 12 | 2740 | 25523 | 12 | 14 |
| 8 | University of California | 81258.45 | 29.2 | 113 | 6 | 2786 | 24257 | 17 | 14 |
| | Los Angeles | | | | | | | | |
| 9 | University of Michigan | 77306.04 | 23.1 | 104 | 8 | 3343 | 23993 | 14 | 13 |
| 10 | University of Southern | 76389.19 | 27.7 | 102 | 14 | 2759 | 25760 | 9 | 20 |
| | California | | | | | | | | |
| 11 | University of | 75294.52 | 25.0 | 116 | 13 | 3016 | 22242 | 16 | 7 |
| | Washington | | | | | | | | |
| 12 | University of Texas | 73734.15 | 22.9 | 107 | 15 | 3224 | 26996 | 8 | 8 |
| | Austin | | | | | | | | |
| 13 | Cornell University | 72117.64 | 36.2 | 117 | 28 | 1994 | 16518 | 7 | 5 |
| 14 | University of Wisconsin | 65272.32 | 28.6 | 113 | 21 | 2281 | 16485 | 41 | 11 |
| | Madison | | | | | | | | |
| 15 | University of California | 64355.73 | 21.9 | 102 | 5 | 2934 | 25860 | 13 | 14 |
| | San Diego | | | | | | | | |
| 16 | University of Minnesota | 59021.07 | 22.7 | 92 | 10 | 2604 | 18725 | 34 | 35 |
| 17 | Columbia University | 57890.46 | 30.9 | 91 | 16 | 1873 | 16475 | 17 | 17 |
| 18 | Princeton University | 57189.62 | 44.8 | 104 | 20 | 1276 | 14645 | 4 | 8 |
| 19 | Purdue University | 56405.08 | 20.0 | 92 | 19 | 2814 | 22403 | 15 | 20 |
| 20 | University of | 54316.84 | 28.8 | 103 | 45 | 1889 | 15288 | 30 | 20 |
| | Massachusetts Amherst | | | | | | | | |
| 21 | University of California | 51333.04 | 28.7 | 89 | 24 | 1790 | 16958 | 21 | 28 |
| | Irvine | | | | | | | | |
| 22 | University of | 50660.41 | 31.3 | 90 | 17 | 1616 | 13004 | 28 | 17 |
| | Pennsylvania | | | | | | | | |
| 23 | Rutgers University | 49438.86 | 31.0 | 92 | 25 | 1595 | 15981 | 25 | 28 |
| 24 | California Institute of | 45189.05 | 33.4 | 88 | 23 | 1352 | 9658 | 10 | 11 |
| | Technology | | | | | | | | |
| 25 | Harvard University | 42441.6 | 16.5 | 83 | 7 | 2571 | 14138 | 5 | 17 |
| 26 | Pennsylvania State | 38848.23 | 15.2 | 71 | 26 | 2564 | 18193 | 41 | 28 |
| | University | | | | | | | | |
| 27 | University of California | 36009.39 | 25.3 | 74 | 37 | 1425 | 11964 | 27 | 35 |
| | Santa Barbara | | | | | | | | |
| 28 | University of North | 35917.43 | 31.4 | 80 | 39 | 1144 | 8830 | 22 | 20 |
| | Carolina Chapel Hill | | | | | | | | |
| 29 | Ohio State University | 34019.76 | 16.1 | 67 | 33 | 2110 | 15015 | 28 | 28 |
| 30 | University of Colorado | 33237.4 | 22.4 | 74 | 41 | 1485 | 10236 | 26 | 39 |
| | Boulder | | | | | | | | |
| 31 | Yale University | 28887.68 | 27.4 | 69 | 18 | 1056 | 8760 | 20 | 20 |
| 32 | Texas A&M University | 28474.24 | 13.3 | 57 | 27 | 2141 | 14216 | 41 | 47 |
| 33 | Rice University | 26423.15 | 32.6 | 75 | 47 | 811 | 7948 | 34 | 20 |
| 34 | New York University | 26142.26 | 25.0 | 73 | 42 | 1045 | 8531 | 34 | 28 |
| 35 | University of Virginia | 26021.63 | 20.8 | 64 | 48 | 1252 | 8426 | 32 | 28 |
| 36 | University of California | 25739.79 | 15.6 | 69 | 29 | 1647 | 11589 | 30 | 39 |
| | Davis | | | | | | | | |
| 37 | Brown University | 25208.12 | 32.7 | 70 | 46 | 771 | 7975 | 34 | 20 |
| 38 | Northwestern University | 25198.38 | 18.6 | 60 | 35 | 1353 | 11347 | 33 | 35 |
| 39 | Duke University | 24907.47 | 17.9 | 62 | 31 | 1389 | 10625 | 24 | 27 |
| 40 | Johns Hopkins | 24738.61 | 15.6 | 63 | 34 | 1582 | 10999 | NR⁴ | 28 |
| | University | | | | | | | | |
| 41 | Boston University | 24193.62 | 22.1 | 68 | 32 | 1097 | 9774 | 41 | 47 |
| 42 | Washington University | 22161.58 | 21.0 | 65 | 30 | 1057 | 7645 | NR⁴ | 39 |
| | in St. Louis | | | | | | | | |
| 43 | Rensselaer Polytechnic | 21734.5 | 17.0 | 60 | 44 | 1280 | 9449 | NR⁴ | 47 |
| | Institute | | | | | | | | |
| 44 | Virginia Tech | 20701.25 | 9.5 | 53 | 36 | 2180 | 13664 | NR⁴ | 4 |
| 45 | University of Arizona | 20694.63 | 12.7 | 58 | 38 | 1632 | 10419 | 34 | 47 |
| 46 | Stony Brook University | 20471.27 | 26.6 | 56 | 49 | 770 | 7400 | NR⁴ | |
| 47 | University of Florida | 20040.97 | 10.2 | 50 | 22 | 1960 | 13455 | 34 | 39 |
| 48 | University of Rochester | 19451.28 | 25.7 | 67 | 50 | 756 | 5965 | NR⁴ | 4 |
| 49 | University of Utah | 17729.43 | 14.7 | 56 | 40 | 1205 | 7915 | 34 | 39 |
| 50 | Dartmouth College | 14487.19 | 26.7 | 50 | 51 | 543 | 4211 | NR⁴ | |
| 51 | University of Chicago | 13922.64 | 18.4 | 55 | 43 | 758 | 5644 | 41 | 35 |
| 52 | University of North | 9049.804 | 17.2 | 29 | 52 | 525 | 3561 | 23 | 47 |
| | Carolina Charlotte | | | | | | | | |

The Spearman and Kendall correlation data are in Tables 2 and 3 for the data from top 50 American universities ranked by USNWR. The reason for the use of Kendall and Spearman correlation measures, instead of the Pearson correlation coefficient, is to capture the correlative relationships better among trends in terms of different bibliometric indicators, since these relationships are not always linear; for example, the ac-index is proportional to the square of the ah-index.

TABLE 2
Spearman correlation among competing ranks.

| Spearman | ac- | aac- | ah- | aj- | | |
|---|---|---|---|---|---|---|
| correlation | index | index | index | index | USNWR | ARWU |
| ac-index | 1 | | | | | |
| aac-index | 0.6478 | 1 | | | | |
| ah-index | 0.9622 | 0.7383 | 1 | | | |
| aj-index | 0.8349 | 0.3606 | 0.7572 | 1 | | |
| USNWR | 0.8704 | 0.7082 | 0.8835 | 0.7284 | 1 | |
| ARWU | 0.7858 | 0.5662 | 0.7635 | 0.7185 | 0.8080 | 1 |

TABLE 3
Kendall correlation among competing ranks.

| Kendall | ac- | aac- | ah- | aj- | | |
|---|---|---|---|---|---|---|
| correlation | index | index | index | index | USNWR | ARWU |
| ac-index | 1 | | | | | |
| aac-index | 0.4570 | 1 | | | | |
| ah-index | 0.8496 | 0.5495 | 1 | | | |
| aj-index | 0.6696 | 0.2232 | 0.5782 | 1 | | |
| USNWR | 0.7056 | 0.5431 | 0.7271 | 0.5493 | 1 | |
| ARWU | 0.5985 | 0.4136 | 0.6022 | 0.5368 | 0.6600 | 1 |

As shown in Tables 1-3, the results of the compared ranking systems are quite different, with the range [0.3606, 0.9622] for Spearman correlation and the range [0.2232, 0.8496] for Kendall correlation. Given the dominating status and objective nature of the scientific publications and associated others' citations among all the observable variables for institutional assessment, the ac-index provides an important value for institutional ranking, and the aac-index can be easily derived after the normalization with respect to the size of an involved team of coauthors. The ah-index provides a convenient approximate proxy. The aj-index is an indirect measure, since the journal impact factor cannot precisely predict the impact of a particular paper.

In addition, the results show a number of changes in rankings around a middle range among the ac-index, aj-index and USNWR systems. Responsible factors may include historical reputation, total funding, student selectivity and number, and other factors used in traditional ratings. While the USNWR ranking relies on proprietary data, the AWRU ranking is more objective. In contrast to both of these rankings, the embodiments of the present invention offer a much wider coverage of relevant data, allow a significantly higher level of mathematical sophistication, and provide ranking systems for assessment of academic units, such as universities, institutes, colleges, departments, and research groups.

Complementary features that also may be assessed to improve precision include profits generated by spin-off companies, royalties from licensing, and other monetary amounts. Financial credits can be shared among co-workers in the same way using the methods described above, and accordingly taken into account for academic ranking.

The above-described embodiments integrate an axiomatic approach and web technology to analyze large amounts of scientific publications for departmental ranking. The axiomatic indices and self-citation exclusion scheme correct the subjective bias of the current ranking systems. As a result, the rankings are content-wise rich, mathematically rigorous, and dynamically accessible.

In yet another preferred embodiment of the present invention, an axiomatic approach combined with associated bibliometric measures is provided to analyze academic productivity and research funding to quantify co-authors' relative contributions. As described above, individualized scientific productivity measures can be defined based on the a-index. Also, the productivity measure in terms of journal reputation, or the Pr-index, is the sum of the journal impact factors (IF) of one's papers weighted by his/her a-indices respectively. The productivity measure in terms of peers' citations, or the Pc-index, is the sum of the numbers of citations to one's papers weighted by his/her a-indices respectively. While the Pr-index is useful for immediate productivity measurement, the Pc-index is retrospective and generally more relevant. Finally, the Pc*IF index is the sum of the numbers of citations after being individually weighted by both the a-index and journal impact factor. When papers are cited, the Pc*IF index credits high-impact journal papers more than low-impact counterparts, as higher-impact papers generally carry higher relevance or offer stronger support to a citing paper.

A bench-marking test of the embodiment was performed wherein an axiomatic approach and associated bibliometric measures were performed to test the finding of a study by Ginther et al. (Ginther, Schaffer et al. 2011; (Ginther, SchatTer et al. 2011) in which the probability of receiving a U.S. National Institutes of Health (NIH) R01 award was analyzed with respect to the applicant's race/ethnicity. The present invention provides new insight and does not suggest that there is any significant racial bias in the NIH review process, in contrast to the conclusion from the study by D. K. Ginther et al. As a result, this embodiment of the present invention can be used for scientific assessment and management.

In D. K. Ginther et al.: “Race, ethnicity, and NIH research awards,” Science, 19 August 2011, p. 1015 (Ginther, Schaffer et al. 2011), the probability of receiving a U.S. National Institutes of Health (NIH) R01 award was related to the applicant's race/ethnicity. The paper indicated that Black applicants were 10% less likely than white peers to receive an award after control for background and qualification, and suggested “leverage points for policy intervention” (Ginther, Schaffer et al. 2011).

In implementing this embodiment of the invention, a study targeting the top 92 American medical schools ranked in the 2011 US News and World Report, from which the 31 odd-number-ranked schools were selected for paired analysis (schools were excluded if they did not provide online faculty photos or did not allow 1:2 pairing of black versus white faculty members). Data were gathered from September 1 to 5, 2011 on black and white faculty members in departments of internal medicine, surgery, and basic sciences in the 31 selected schools. The ethnicity of faculty members was confirmed by their photos, names, and resumes as needed, and department heads/chairs were excluded. These schools were categorized into three tiers according to their ranking: 1st-31st as the first tier, 33rd-61st as the second tier, and 63rd-91st as the third tier. After 130 black faculty members were found from these schools, 40 black faculty members were randomly selected. The selected 40 black faculty members were 1:2 paired with white peers, yielding 120 samples as our first pool. The pairing criteria include the same gender, degree, title, specialty, and university. The ratio of 1:2 was chosen to represent white faculty members better, since the number of white faculty members is much more than that of black faculty members. Any additional major constraint such as the number of papers would prevent the study from having a sufficient number of pairs.

Among the 130 black samples in the initial list, NIH funded 14 faculty members during the period from 2008 to 2011. Two of 14 black samples were excluded because of failure in matching with any white faculty member. Furthermore, an additional black faculty member was excluded because he only published at conference without any Science Citation Index (SCI) record in this period (http://sub3.weboflknowledge.com). This zero productivity cannot be used as the denominator for the embodiment's bibliometric analyses (see the tables below). Note that this exclusion is actually in favor of drawing a conclusion more favorable to support the conclusion from the study by D. K. Ginther et al. (Ginther, Schaffer et al. 2011; Ginther, Schaffer et al. 2011), and yet as shown below the results of using the present invention produces a conclusion that is different from that by D. K. Ginther et al. Consequently, 11 funded black faculty members were kept. Among them, 10 were from the first tier, and 1 from the second tier. These 11 funded black faculty members were 1:1 paired with white samples that both met the pairing criteria and were funded by NIH in the same period. Consequently, there were 11 pairs of black and white investigators, which is the second pool.

Using the Web of Knowledge (http://sub3.webofknowledge.com), datasets were collected for the two pools of faculty members. Funding and publication records were produced to cover the period from January 2008 to August 2011. Each dataset corresponded to a single black-white combination, and included bibliographic information, such as co-authors, assignment of the corresponding author(s), journal impact factors, and citations received from 2008 to 2011. The journal impact factors were obtained from Journal Citation Reports (http://thomsonreuters.com/products_services/science/science_products/a-z/journal_citation_reports).

The a-index values were computed using the above described axiomatic method. In computing a-index values, the first author(s) and the corresponding author(s) were treated with equal weights in this context. For the NIH-tfunded samples, individual numbers of funded proposals and individual funding totals were found via the NIH Reporter system (http://projectreporter.nih.gov/reporter.cfm).

Features of interest included the number of journal papers, number of citations, Pr-index, Pc-index, and Pc*IF-index. For the second pool samples, additional features were numbers of NIH funded proposals and NIH funding totals per person and per racial group, respectively.

The paired t-tests were performed using SPSS 13.0 on the datasets from the first and second pools. In the first pool, the average data of two white professors were paired to individual data of the corresponding black professor. The tests were specifically performed by professional rank and school reputation, gender and integrated for racial groups. The scientific productivity was evaluated using the Pr-index, Pc-index, and Pc*IF. Statistical significance levels are indicated by “*” for p<0.05 and “**” for p<0.01.

Table 4 suggests that higher scientific productivity was positively correlated with more senior professional titles or more prestigious institutional tiers.

TABLE 4
Scientific publication measures for black and white faculty members in the first pool.

| | | | Mean | | | | |
|---|---|---|---|---|---|---|---|
| | | Number of | Mean of | Number of | | | |
| | Race | Samples | Papers | Citations | Pr-index | Pc-index | Pc*IF-index |
| Full | Black | 3 | 16.33 ± 17.24 | 120.67 ± 144.36 | 17.62 ± 23.21 | 33.24 ± 50.06 | 130.51 ± 202.80 |
| Professor | White | 6 | 17.67 ± 22.87 | 197.83 ± 279.04 | 17.49 ± 19.77 | 20.96 ± 26.88 | 260.35 ± 326.53 |
| Associate | Black | 12 | 5.83 ± 5.75 | 30.00 ± 37.10 | 4.73 ± 5.25 | 4.69 ± 5.35 | 31.32 ± 42.73 |
| Professor | White | 24 | 9.08 ± 8.63 | 52.25 ± 55.76 | 5.38 ± 4.55 | 7.78 ± 6.04 | 41.23 ± 58.22 |
| Assistant | Black | 25 | 2.44 ± 3.11** | 8.88 ± 20.35* | 1.71 ± 2.17** | 0.86 ± 1.29* | 2.87 ± 5.49* |
| Professor | White | 50 | 5.18 ± 4.86 | 31.94 ± 52.94 | 6.05 ± 6.42 | 7.05 ± 11.23 | 48.42 ± 107.01 |
| First Tier | Black | 21 | 5.19 ± 8.18** | 27.62 ± 63.63* | 5.29 ± 9.92* | 6.09 ± 19.63 | 29.13 ± 82.78 |
| (Groups 1-21) | White | 42 | 10.02 ± 10.66 | 70.31 ± 118.28 | 9.22 ± 9.38 | 11.07 ± 14.88 | 87.12 ± 168.07 |
| Second Tier | Black | 8 | 6.00 ± 6.28 | 36.50 ± 45.26 | 3.41 ± 3.36 | 4.91 ± 6.08 | 24.14 ± 29.35 |
| (Groups 22-29) | White | 16 | 5.69 ± 5.32 | 26.44 ± 26.85 | 6.20 ± 5.51 | 6.71 ± 5.77 | 37.82 ± 51.48 |
| Third Tier | Black | 11 | 2.09 ± 1.81 | 6.55 ± 8.66 | 1.26 ± 1.42 | 0.94 ± 1.38 | 3.12 ± 6.82 |
| (Groups 30-40) | White | 22 | 3.23 ± 2.79 | 30.09 ± 53.54 | 2.28 ± 2.33 | 4.21 ± 6.10 | 32.22 ± 64.83 |
| Male | Black | 22 | 6.14 ± 7.91* | 36.55 ± 65.60 | 4.72 ± 9.17** | 6.60 ± 19.27 | 32.58 ± 81.54* |
| | White | 44 | 9.68 ± 10.42 | 66.25 ± 111.14 | 8.79 ± 8.82 | 9.93 ± 11.21 | 75.90 ± 135.35 |
| Female | Black | 18 | 2.50 ± 4.16 | 7.78 ± 11.79 | 2.69 ± 4.71 | 1.79 ± 2.93 | 6.81 ± 11.68 |
| | White | 36 | 4.36 ± 4.50 | 31.19 ± 59.12 | 4.16 ± 5.60 | 6.33 ± 12.44 | 45.37 ± 123.49 |
| Total | Black | 40 | 4.50 ± 6.68** | 23.60 ± 50.87* | 3.81 ± 7.49** | 4.44 ± 14.48 | 20.98 ± 61.71* |
| | White | 80 | 7.29 ± 8.63 | 50.48 ± 92.12 | 6.71 ± 7.81 | 8.31 ± 11.77 | 62.16 ± 129.42 |
| | Ratio | 0.5 | 0.62 | 0.47 | 0.57 | 0.53 | 0.34 |

Furthermore, the analysis shows the male investigators were statistically more productive than the female colleagues, and the black faculty members statistically less productive than the white colleagues. The distribution of professional titles (Full, Associate, and Assistant Professor) for the black faculty members was 3:12:25, indicating an imbalance in the higher ranks. Despite that more than half of the black samples were from first tier institutions, 14 were assistant professors. Thus, the numbers of black associate and full professors were insufficient for us to devise title-specific conclusions with statistical significance.

Table 5 focuses on the scientific productivities of the NIH funded black and white investigators, and indicates similar racial differences in scientific productivity. Although statistical significance cannot be established per professional title due to the limited numbers of samples, the differences between the racial groups are significant in terms of the number of citations and the Pc-index. In the following analysis, these scientific productivity measures serve as the base to evaluate the fairness of the NIH funding process. Note that the racial/ethnic differences in Pr and Pc (Tables 4 and 5) are consistent with the citation analysis performed in (Ginther, Schaffer et al. 2011).

TABLE 5
Scientific publication measures for black and white faculty members in the second pool.

| | | Mean | | | | |
|---|---|---|---|---|---|---|
| | Number of | Number of | Number of | | | |
| Race | Samples | Papers | Citations | Pr-index | Pc-index | Pc*IF-index |
| Black | 11 | 10.45 ± 9.02 | 88.64 ± 98.30* | 11.13 ± 12.47 | 14.96 ± 24.11* | 90.43 ± 124.94 |
| White | 11 | 18.64 ± 14.18 | 203.73 ± 189.02 | 18.03 ± 13.24 | 34.39 ± 43.82 | 318.42 ± 474.53 |
| Ratio | 1 | 0.56 | 0.44 | 0.62 | 0.44 | 0.28 |

In Tables 6 and 7, the funding support and the number of funded projects for each racial group were normalized by Pr, Pc and Pc*IF respectively. In addition to the racial difference in the R01 success rates (Ginther, Schaffer et al. 2011), it can be seen in Tables 6 and 7 that the funding total and the number of funded projects for black NIH investigators were only 46% and 62% of that for whites, respectively. However, when these funding totals and numbers of funded projects were normalized by Pr, the ratios between black and white faculty members were narrowed. Furthermore, the normalization by the citation-oriented indices Pc and Pc*IF indicates that black faculty members had more favorable ratios from 1.06 to 2.00.

TABLE 6
Ratios between the total funding amount and the
accumulated scientific publication measurement for
racial groups (not individuals) in the second pool.

| | | | | | Funding |
|---|---|---|---|---|---|
| | | | Funding | Funding | Total |
| | | | Total | Total | Normal- |
| | Number | | Normalized | Normalized | ized |
| | of | Funding | by Pr- | by | by Pc*IF- |
| Race | Samples | Total | index | Pc-index | index |
| Black | 11 | 20140082 | 164565.69 | 122423.76 | 20247.54 |
| White | 11 | 43796537 | 220860.92 | 115781.91 | 12503.74 |
| Ratio | 1 | 0.46 | 0.75 | 1.06 | 1.62 |

TABLE 7
Ratios between the total number of NIH-funded projects and
the accumulated scientific publication measurement for
racial groups (not individuals) in the second pool.

| | | | Number of | Number of | Number of |
|---|---|---|---|---|---|
| | | | Projects | Projects | Projects |
| | | Number | Normalized | Normalized | Normalized |
| | Number of | of | by | by | by |
| Race | Samples | Projects | Pr-index | Pc-index | Pc*IF-index |
| Black | 11 | 22 | 0.180 | 0.134 | 0.022 |
| White | 11 | 37 | 0.187 | 0.098 | 0.011 |
| Ratio | 1 | 0.59 | 0.96 | 1.37 | 2.0 |

There are apparent differences in research performance by major racial groups based on individual scientific publication measures. These findings are consistent with previous reports (Ginther, Schaffer et al. 2011). The application of the new scientific productivity indices of the present invention to the racial groups (Tables 5 and 6) clarifies the source of discrepant funding successes. When the total grant amounts and the number of funded projects were racial-group-wise normalized by these indices, the NIH review process does not appear biased against black faculty members (Tables 7 and 8). Although the funding total and the number of funded projects for black NIH investigators were respectively only 46% and 62% of that for white peers, when these totals and the numbers were normalized by Pr, the ratios between black and white faculty members neared parity. Furthermore, the normalization by the citation-oriented indices Pc and Pc*IF indicates that black researchers have not been in a disadvantageous position.

The key results achieved statistical significance in the paired analysis that was capable of sensing differences with adequate specificity and sensitivity. There is a potential for the axiomatic approach to produce more comprehensive results with expansion of the sample sets.

The construction of the databases used in this study took 10 researchers about three months to assemble. However, the databases are still much smaller than those used in the Ginther study (The Ginther study “included 83,188 observations with non-missing data for the explanatory variables” (Ginther, Schaffer et al. 2011)). On the other hand, if detailed information were used on educational background, training, prior awards, and related variables, pairing of black and white investigators would become impossible in many cases. Axiomatically-formulated scientific productivity and accordingly-defined funding normalization allows for the evaluation of the fairness of the NIH review process in a more straightforward way, yielding statistical significance with smaller sample sizes.

As shown above, the axiomatic approach can be useful in multiple ways. For example, it may help streamline and monitor peer-review and research execution. Optimization of the NIH funding process has been a public concern. The NIH Grant Productivity Metrics and Peer Review Scores Online Resource stimulated hypotheses that can be tested using the axiomatic indices.

Based on the above, one embodiment of the present invention provides a computer-implemented process that utilizes digital resources, which may be mined from the world wide web (Web), to objectively rank an author, academic unit or organization based on publications having a plurality of authors. The steps that may be implemented include (a) assigning credit to an author, academic unit or organization axiomatically; (b) finding self-citations pertaining to each author, academic unit or organization; (c) removing self-citations relating to each author, academic unit or organization; and (d) ranking the author, academic unit or organization according to results of steps (a) through (b). The number of citations to each publication may also be proportionally assigned to each co-author, academic unit or organization. The system may also be implemented to determine an a-index for each author. The a-index is calculated by applying a first axiom wherein a better ranked co-author has a higher credit; applying a second axiom wherein the sum of individual credits equals 1; and applying a third axiom wherein each of said co-authors' credit shares are uniformly distributed in the space defined by the first and second axioms. When the resources indicate there is no evidence that some co-authors made an equal contribution, then the k-th co-author of a publication by n co-authors has an a-index

$$\frac{1}{n} {\sum }_{j = k}^{n} \frac{1}{j} ;$$

and if the resources indicate there are no other two co-authors who have the same amount of credit but there is a corresponding author, then the first or corresponding authors credit's is

$$\frac{1}{n - 1} {\sum }_{j = 1}^{n - 1} \frac{1}{j + 1} ,$$

and the k-th co-author's credit is

$$\frac{1}{n - 1} {\sum }_{j = k}^{n - 1} \frac{1}{j + 1} ,$$

k≠1 and k≠n.

The system individualizes citations when a co-author with an a-index value c for a publication being cited M times gains c*M citations to the publication. The system may exclude self-citations axiomatically. This may be done by using the axiomatic strength of a citation to one author's share or one unit's share in a paper and excluding it from another author's or another unit's in the citing paper as shown in FIG. 2.

In another implementation, the credit for an institution identified in the publication is measured as the sum of the credits earned by those co-authors who are with the institution. The process described above may also be implemented to objectively rank an academic unit of an organization based on publications.

In other embodiments of the present invention, the subject to be ranked may include authors, co-authors, departments, colleges, contributors, universities, companies or any other entity that may be ranked using the published works associated with the entity. The rankings resulting from the invention may then be used in grant selection, grant management, to monitor efficiency, determine potential bias (white versus black, male versus female, junior versus senior, etc.) and in other applications in which an objective analysis of performance or some other metric is desired such selecting reviewers for paper review, monitoring efficiency in terms of research output versus invested resources such as total funding.

In other embodiments, the system of the present invention may be based on real-time data mining, based on off-line processing and/or used in combination with subjective criteria. Other embodiments include using the system with an existing ranking system or systems. Also, the system may use in the ranking analysis other works or data sources such as books, patents, or website pages.

In the event the resources indicate other combinations of ranking designations, the individualized credits can be computed by assuming that each publication has n co-authors in m subsets (n≧m) where co-authors in the i-th subset have the same credit xi in x=(x1, x2 . . . , xm) (1≦i≦m). The axiomatic system consists of the following three postulations: Axiom 1 (Ranking Preference): x1≧x2≧ . . . ≧xm≧0; Axiom 2 (Credit Normalization): c1 x1+c2x2+ . . . +cm xm=1; and Axiom 3 (Maximum Entropy): x is uniformly distributed in the domain defined by Axioms 1 and 2.

The system of the present invention may also be used to measure, analyze or quantify other metrics involving the individual effort or collective effort of a plurality of individuals, groups or units. Such metrics can be anything that is measurable and may include the performance of employees working in a group or unit, or groups or units that are subsets of larger groups, units, organizations or entities. For example, in one embodiment, the present invention may be used to measure a metric such as an employee's performance for situations requiring the evaluation of credit/performance of one unit or person, a subject, that is a part of a larger team or unit. In a preferred embodiment, this may be done by using an axiomatic approach in connection with a computer-implemented process that utilizes digital and/or other resources to objectively rank a subject based on team achievements contributed by at least one subject comprising the steps of (a) assigning individualized credit to each subject axiomatically; and (b) ranking said subject according to results of step (a) which could be used in combination with other means or systems.

While the present invention has a potential to be widely used for scientific assessment and management, the foregoing written description of the inventions enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention as claimed.

What is claimed is:

1. A computer-implemented process that utilizes digital and/or other resources to objectively rank a subject based on publications having a plurality of authors or academic units comprising the steps of:
(a) assigning individualized credit to each subject axiomatically;
(b) finding self-citations pertaining to each subject;
(c) removing self-citations relating to each subject; and
(d) ranking said subject according to results of steps (a) through (b).

2. The system of claim 1 wherein the number of citations to each publication is proportionally assigned.

3. The system of claim 1 wherein an a-index for said subject is calculated, said a-index calculated by applying a first axiom wherein a better ranked co-author or academic unit has a higher credit; applying a second axiom wherein the sum of individual credits equals 1; and applying a third axiom wherein said co-authors' or academic units' credit shares are uniformly distributed in the space defined by said first and second axioms;
when said resources indicate there is no evidence that some co-authors or academic units made an equal contribution, then the k-th co-author or academic units of a publication by n co-authors has an a-index
$$\frac{1}{n} {\sum }_{j = k}^{n} \frac{1}{j} ;$$
and
if said resources indicate there are no other two co-authors who have the same amount of credit but there is a corresponding author, then the first or corresponding authors credit's is
$$\frac{1}{n - 1} {\sum }_{j = 1}^{n - 1} \frac{1}{j + 1} ,$$
and the k-th co-author's credit is
$$\frac{1}{n - 1} {\sum }_{j = k}^{n - 1} \frac{1}{j + 1} ,$$
k≠1 and k≠n.

4. The method of claim 3 when said resources indicate other combinations of ranking designations, the individualized credit is computed by assuming that each publication has n co-authors in m subsets (n≧m) where co-authors in the i-th subset have the same credit xi in x=(x1, x2 . . . , xm) (1≦i≦m) using a first axiom wherein x1≧x2≧ . . . ≧xm≧0; a second axiom wherein c1x1+c2x2+ . . . +cm xm=1; and a third axiom wherein x is uniformly distributed in the domain defined by said first and second axioms.

5. The system of claim 3 wherein citations to the publication are individualized when a subject with an a-index value c for a publication being cited A times gains c*M citations to the publication.

6. The system of claim 1 wherein self-citations are axiomatically excluded.

7. The system of claim 6 wherein self-citations are axiomatically excluded using the axiomatic strength of a citation to one subject's share in a paper from the others' share in the citing paper.

8. The system of claim 1 wherein the credit for an institution identified in the publication is measured as the sum of the credits earned by those co-authors who are with the institution.

9. The system of claim 1 wherein the system is used to review grant selection.

10. The system of claim 1 wherein the system is used to manage grants.

11. The system of claim 1 wherein the system is used to determine biases.

12. The system of claim 1 wherein the system is based on real-time data mining.

13. The system of claim 1 wherein the system is based on off-line processing.

14. The system of claim 1 wherein the system is used in combination with subjective criteria.

15. The system of claim 1 wherein the system is used with an existing ranking system.

16. The system of claim 1 wherein the system uses in the ranking analysis books, patents, or website pages.

17. The system of claim 1 wherein the system is used to monitor efficiency.

18. The system of claim 1 wherein the system is used to select reviewers for paper review.

19. The system of claim 1 wherein the system is used to monitor efficiency in terms of research output versus invested resources.

20. The system of claim 1 wherein the system is used to monitor efficiency in terms of research output versus total funding.

21. A computer-implemented process that utilizes digital and/or other resources to objectively measure a metric for a group of subjects based on publications and/or other forms of teamwork results comprising the steps of (a) assigning individualized credit to each subject axiomatically; and (b) ranking each subject according to the results of step (a).
